(19) United States
(12) Patent Application Publication
(10) Pub. No.: US 2025/0067351 A1
(43) Pub. Date: Feb. 27, 2025

(54) HYDRAULIC VALVE SPOOL THROUGH WHICH A FLUID CAN FLOW, BIDIRECTIONAL CONTROL VALVE, AND METHOD

(71) Applicant: ETO MAGNETIC GMBH, Stockach (DE)

(72) Inventors: Sebastian BÖLLING, Uhldingen-Mühlhofen (DE); Timo RIGLING, Moos (DE); Luca VESER, Radolfzell (DE)

(21) Appl. No.: 18/721,829

(22) PCT Filed: Dec. 19, 2022
(86) PCT No.: PCT/EP2022/086736

§ 371 Date: Oct. 14, 2024

(30) Foreign Application Priority Data
Dec. 23, 2021 (DE) 10 2021 134 609.6

(51) Int. Cl. F16K 11/07; B60G 17/08; F15B 1/26; F15B 13/02; F15B 13/04; F16K 31/383

(52) U.S. Cl. CPC F16K 11/0716; B60G 17/08; F15B 1/265; F15B 13/028; F15B 13/0401; F16K 31/383; B60G 2202/415; B60G 2204/62; B60G 2500/114; B60G 2600/21; B60G 2800/162; B60G 2800/916

(57) ABSTRACT

A flow-through hydraulic valve slide (14a-b), in particular for a control valve (10a-b) for regulating damping characteristics of shock absorbers, has at least one hydraulic link valve (12a-b) for influencing a flow-through of the valve slide (14a-b), wherein the hydraulic link valve (12a-b) comprises at least one first control port (16a-b), at least one second control port (18a-b), at least one entry (20a-b, 36a-b) and at least one exit (22a-b, 40b) which can be opened in an interchangeable manner at least towards the entry (20a-b).

### PRIOR ART

The invention concerns a valve slide according to claim 1, a control valve according to the preamble of claim 16, a vehicle according to claim 19 and a method according to claim 20.

It has been proposed that closed volumes which are displaced or filled by a movement of a valve slide are equipped with large leakages in bearing gaps in order to compensate the surplus or deficient volumes.

The objective of the invention is in particular to provide a generic device with advantageous damping properties. The objective is achieved according to the invention by the features of claims 1, 16, 19 and 20, while advantageous implementations and further developments of the invention may be gathered from the subclaims.

### ADVANTAGES OF THE INVENTION

A flow-through hydraulic valve slide, in particular for a control valve for regulating damping characteristics of shock absorbers, is proposed, with at least one hydraulic link valve for influencing a flow-through of the valve slide, wherein the hydraulic link valve comprises at least one first control port, at least one second control port, at least one entry and at least one exit, preferably at least two exits, which can be opened in an interchangeable manner at least towards the entry. In this way, advantageous damping properties are achievable. Advantageously, a damping characteristic for shock absorbers is achievable, which at the same time has high dynamics and low overall leakage. Advantageously, a conflict of objectives between dynamics and leakage, which occurs in known control valves (there, high dynamics generally means high leakage) can be resolved by the invention. Advantageously, due to low overall leakage, regulation is enabled even at low damper speeds, in particular as a particularly low opening point of the control valve is achievable. Advantageously, the overall leakage can be optimized independently of the dynamics to be achieved, for example as it is possible either to significantly reduce leakage (functional advantage) with a constant manufacturing tolerance or as it is advantageously possible to augment manufacturing tolerances without producing particularly disadvantageous effects (cost advantage).

In particular, the valve slide implements a component of the control valve for regulating the damping characteristics of shock absorbers. The valve slide in particular separates a pressure side of a shock absorber comprising the control valve from a pressure-free side of the shock absorber. In particular, the pressure side may change depending on the application of a tensile force or of a compressive force. Opening of the separation of pressure side and pressure-free side by the valve slide will induce damping by means of an oil flow. In particular, the valve slide comprises hydraulic effective surfaces. In particular, the valve slide comprises at least one hydraulic effective surface and at least one further hydraulic effective surface, wherein the hydraulic effective surface and the further hydraulic effective surface(s) are arranged on the valve slide relative to each other in such a way that they hydraulically counteract each other, in particular during a damping process, and wherein the tensile or compressive forces of the shock absorber that are to be damped in particular act on the hydraulic effective surfaces. In particular, the valve slide can be at least section-wise flowed through by a fluid, for example an oil, preferably a hydraulic oil. In particular, the flow-through capability of the valve slide achieves that oil, in particular hydraulic oil, can be pumped back and forth between a pressure fluid reservoir of the control valve and a pressure-free (pressure fluid) tank of the shock absorber. Herein in particular the assignment of the pressure-free region, i.e. of the pressure-free (pressure fluid) tank, changes depending on the flow-through direction. This switchover is advantageously achieved substantially without substantial leakage losses and without undesired build-up of substantial counter-forces. This advantageously allows achieving high switching dynamics of the control valve with a chassis regulation starting already at small chassis vibrations. In particular, the valve slide can be flowed through bidirectionally. In particular, the valve slide comprises at least four different flow-through paths. In particular, the hydraulic link valve is configured for influencing a flow-through of at least two of the four flow-through paths, preferably of all four flow-through paths. In particular, the link valve is integrated in the valve slide. In particular, the link valve is completely enclosed by the valve slide. In particular, at least one of the control ports, preferably all control ports, at the same time forms/form entries of the link valve. In particular, the hydraulic pressures applied at the control ports of the link valve control the link valve, in particular the valve position of the link valve. In particular, the link valve is free of an electronic, magnetic and/or mechanical control. In particular, the link valve is controlled/operated in a purely fluid-mechanical manner. In particular, the link valve is flowed through by the pressure fluid. In particular, the control ports are actuatable/actuated by pressure signals. In particular, the entry may coincide with at least one of the control ports. In particular, the link valve may comprise two entries, wherein the two entries may coincide with respectively different control ports. Alternatively, it is conceivable that at least one entry is realized separately from a control port and/or that at least one control port does not form an entry into which a fluid flowing through the link valve can enter.

Furthermore, it is proposed that the flow-through hydraulic valve slide comprises a sealing surface that is configured to tightly sit on a valve seat of the control valve, wherein the first control port is hydraulically connected to a first side of the valve slide, wherein the second control port is hydraulically connected to a second side of the valve slide, and wherein the two sides to which the control ports are hydraulically connected are arranged on the valve slide in such a way that the first side and the second side can be sealed relative to each other by the sealing surface. In this way, advantageous damping properties are achievable. Advantageously, in this way a controlling of the link valve, in particular a connection to the exit of the link valve, is achievable, depending on the pressures applied to the two sides from an outside. In particular, the sides of the valve slide are hydraulically separate from each other when the valve slide sits on the valve seat in a sealing manner. In particular, there is always one of the control ports arranged on a pressure side of the valve slide, while the other one of the control ports is arranged on a pressure-free side of the valve slide. In particular, the opening point of the shock absorber is the point in which the valve slide is lifted from the valve seat. The valve slide is configured to generate, depending on its opening position, a damping of an applied tensile or compressive force. If an acting tensile or compressive force is large enough to lift the valve slide from the valve seat, a pressure fluid will flow between the two sides, as a result of which a damping of the acting tensile or compressive forces will be generated. The control valve is configured to adjust, for example by means of magnetic fields, the damping force/damping hardness by influencing the opening movement of the valve slide. The valve slide is connected to a magnet armature of an electromagnet. The electromagnet is configured to generate a force opposed to an opening movement of the valve slide. “Configured” is in particular to mean specially programmed, designed and/or equipped. In particular, the sealing surface is arranged on a side of the valve slide facing away from the electromagnet, wherein a reverse implementation is generally also conceivable.

By an object being configured for a specific function is in particular to be understood that the object fulfils and/or carries out this specific function in at least one application state and/or operation state.

In addition, it is proposed that the exit, which is preferably different from the control ports, is hydraulically connected to a third side of the valve slide, which is arranged opposite the sealing surface as viewed in a designated movement direction of the valve slide. In this way, advantageous damping properties are achievable. Advantageously, a regulatable (at least section-wise axial) flow-through of the valve slide is attainable. In particular, the exit, which is different from the control ports, is open to a side of the valve slide that is arranged opposite the sealing surface in the axial direction of the valve slide. In particular, the exit is connected either to a hydraulic effective surface, in particular a hydraulic effective surface differing from the hydraulic effective surfaces onto which chassis vibrations are exerted, or to the pressure fluid reservoir.

If the hydraulic link valve is realized as a two-pressure valve, which is in particular configured to open and/or keep open the entry to which the control port having the lower pressure is assigned, in particular the control port of the two control ports at which a lower pressure is applied, towards the exit, which is in particular different from the control ports, preferably the exit of the two-pressure valve, advantageous damping properties are achievable. Advantageously, a selective regulation of the flow-through of the valve slide is achievable. Advantageously, in this way an exchange, which is as resistance-free as possible, is enabled between the pressure fluid reservoir of the control valve and the pressure-free (pressure fluid) tank of the shock absorber. Advantageously, leakage can be kept low while enabling high-grade dynamics. The valve slide in particular comprises at least one flow channel with at least one branching, wherein preferably each branch path forms respectively one of the four flow-through paths. At the branching, a first sub-channel of the flow channel, a second sub-channel of the flow channel and a third sub-channel of the flow channel meet. Preferably the first sub-channel of the flow channel and the second sub-channel of the flow channel together form the first flow-through path of the valve slide. Preferably the first sub-channel of the flow channel and the third sub-channel of the flow channel together form the second flow-through path of the valve slide. The two-pressure valve is in particular arranged in the branching of the flow channel and is configured to open and/or keep open the first sub-channel towards that one of the two further sub-channels at which a lower pressure is applied. Preferably, the two-pressure valve at the same time closes the first sub-channel towards that one of the two further sub-channels that has the higher pressure.

Furthermore, it is proposed that the exit of the two-pressure valve is hydraulically connected to a region of the valve slide which at least partially delimits the pressure fluid reservoir of the control valve, wherein the pressure fluid reservoir is in particular configured to be filled and/or emptied during a movement of the valve slide via a flow-through path that is controlled at least by the two-pressure valve. In this way, advantageous damping properties are achievable. Advantageously, a selective regulation of the flow-through of the valve slide is achievable. Advantageously, in this way an exchange, which is as resistance-free as possible, is enabled between the pressure fluid reservoir of the control valve and the pressure-free (pressure fluid) tank of the shock absorber. In particular, the two-pressure valve ensures that the flow-through path always opens into the currently pressure-free (pressure fluid) tank and thus the filling and emptying of the pressure fluid reservoir during a movement of the valve slide proceeds at least substantially in a resistance-free manner.

If the hydraulic link valve is realized as a shuttle valve, which is in particular configured to open and/or keep open the entry to which the control port having the higher pressure is assigned, in particular to open and/or keep open that control port of the two control ports at which a higher pressure is applied, towards the exit, which is in particular different from the control ports, preferably the exit of the shuttle valve, advantageous damping properties are achievable. Advantageously, a selective regulation of the flow-through of the valve slide is achievable.

Advantageously, in this way a transmission of forces, in particular shock absorber tensile forces and/or shock absorber compressive forces, which is as efficient and/or dynamic as possible, is enabled to the hydraulic effective surface of the valve slide, which is configured to generate a counterforce to the forces. In particular, the hydraulic effective surface is larger than the further hydraulic effective surface(s), in particular independently of whether further connectable hydraulic effective sub-surfaces are connected to the hydraulic effective surface or not. The valve slide in particular comprises at least one further flow channel with at least one branching, wherein preferably each branch path forms respectively one of the four flow-through paths. At the branching, a first sub-channel of the further flow channel, a second sub-channel of the further flow channel and a third sub-channel of the further flow channel meet. Preferably the first sub-channel of the further flow channel and the second sub-channel of the further flow channel together form the third flow-through path of the valve slide. Preferably the first sub-channel of the further flow channel and the third sub-channel of the further flow channel together form the fourth flow-through path of the valve slide. The shuttle valve is in particular arranged in the branching of the further flow channel and is configured to open and/or keep open the first sub-channel towards that one of the two further sub-channels at which a higher pressure is applied. Preferably the two-pressure valve at the same time closes the first sub-channel towards that one of the two further sub-channels that has the lower pressure. The shuttle valve is in particular configured to hydraulically separate the respectively currently pressure-free side from the first sub-channel of the further flow channel. The shuttle valve in particular ensures that a flow-through path of the exit of the further flow channel always opens into the currently pressure-loaded tank and thus the pressure also acts on the (upper) hydraulic effective surface, which is in particular configured to generate a counterforce to the shock absorber tensile forces and/or shock absorber compressive forces.

In the following, it is proposed that the exit of the shuttle valve is hydraulically connected to a hydraulic effective surface, in particular of the valve slide, which is situated opposite a further hydraulic effective surface, in particular of the valve slide, which is realized on the side of the valve slide towards which the shuttle valve, in particular the control port of the shuttle valve, is currently open. In this way, advantageous damping properties are achievable. Advantageously, in this way a transmission of forces, in particular shock absorber tensile forces and/or shock absorber compressive forces, which is as efficient and/or dynamic as possible, is enabled to the hydraulic effective surface of the valve slide, which is configured to generate a counterforce to said forces.

Beyond this, it is proposed that the opposite-situated hydraulic effective surfaces have different dimensions. In this way, advantageous damping properties are achievable. Advantageously, a pressure-dependent force difference between the opposite-situated sides of the valve slide is achievable. In particular, the hydraulic effective surface is larger than each of the further hydraulic effective surfaces. In particular, the hydraulic effective surface, preferably a totality of all hydraulic effective sub-surfaces of the hydraulic effective surface, is by at least 3%, preferably by at least 5%, advantageously by at least 10%, preferably by at least 15% and preferentially by at most 25% larger than the respective opposite-situated further hydraulic effective surface on the pressure side or tension side.

In addition, it is proposed that the flow-through hydraulic valve slide comprises at least one further hydraulic link valve, which in particular differs from the hydraulic link valve in a functional principle, for influencing a flow-through of the valve slide, wherein the further hydraulic link valve comprises at least one first control port and at least one second control port and in particular has at least one exit, which can be opened in an interchangeable manner towards at least one of the control ports. In this way, advantageous damping properties are achievable. As a result, advantageous flow-through properties of the valve slide are achievable for the damping. In particular, the hydraulic link valve and the further hydraulic link valve have different exits, which are in particular realized separately from each other and/or are sealed with respect to one another.

If herein the hydraulic link valve is realized as a two-pressure valve and the further hydraulic link valve is realized as a shuttle valve, high dynamics can advantageously be achieved with at the same time low leakage. In particular, the two-pressure valve and the shuttle valve are respectively enclosed by the valve slide. In particular, the two-pressure valve and the shuttle valve are realized separately from each other. In particular, the respective movement axes of the valve elements of the two-pressure valve and the shuttle valve extend in directions which are not parallel to each other.

If herein moreover the hydraulic link valve is assigned to the flow channel (one of the exits) realized at least partially by the valve slide and the further hydraulic link valve is assigned to the further flow channel (other of the exits) realized at least partially by the valve slide, wherein the two flow channels are realized completely separate from each other, in particular without connection to each other, it is advantageously possible to achieve high dynamics and at the same time low leakage.

Alternatively, it is proposed that the hydraulic link valve is realized as a single valve, which has at least one further exit and which combines the function of a shuttle valve with the function of a two-pressure valve in one valve. This advantageously allows further reducing complexity, in particular by further reduction of a number of components. Advantageously, costs can be kept low as a result. In particular, in such a case the valve slide is free of further valves, such as further shuttle valves or further two-pressure valves. In particular, the single valve is arranged at the same time in the first flow channel and in the second flow channel of the valve slide.

It is further proposed that the single valve is embodied as a 4/2 shuttle valve, which is configured to open and/or keep open the entry assigned to that control port of the two control ports at which, in particular viewed relatively, a higher pressure is applied, towards the exit, in particular towards the exit of the link valve which is hydraulically connected to the hydraulic effective surface, and at the same time to open and/or keep open the entry assigned to that control port of the two control ports at which, in particular viewed relatively, a lower pressure is applied, towards the further exit, in particular towards the exit of the link valve which is hydraulically connected to the pressure fluid reservoir. In this way, the functions of a shuttle valve and of a two-pressure valve can advantageously be combined in a single valve. In this way, complexity and costs are advantageously reducible.

Furthermore, it is proposed that the hydraulic link valve that is embodied as a 4/2 shuttle valve comprises a combination-valve valve slide which is at least section-wise capable of being flowed through. In this way, high compactness is advantageously achievable. Moreover, an advantageous valve configuration is achievable, which is in particular suitable for combining the functions of a two-pressure valve and a shuttle valve in a single valve. In particular, the combination-valve valve slide comprises an, in particular internal, flow channel which extends at least over a large portion of a longitudinal extent of the combination-valve valve slide.

It is also proposed that, in particular apart from the hydraulic link valve and/or apart from the further hydraulic link valve, the flow-through hydraulic valve slide has an orifice-free configuration. This advantageously allows keeping a complexity and in particular a number of components at a low level. An “orifice” is in particular to mean a local flow resistance element with a step-like cross-section constriction, in which a ratio of length to diameter is comparably small, preferably smaller than 1.5.

Furthermore, a—preferably proportional—bidirectional control valve is proposed for regulating damping characteristics, in particular of shock absorbers, with the flow-through hydraulic valve slide. This allows providing advantageous damping properties and/or damping characteristics. In particular, the bidirectional control valve is configured for a regulation of the damping characteristics in two directions, preferably in a rebound direction and in a compression direction. A “proportional bidirectional control valve” is in particular to mean a bidirectional control valve configured for regulating a damping force, preferably of a shock absorber, in a current-proportional manner. In particular, the bidirectional control valve is configured, with a bidirectional flow-through, to always conduct a compensation of a fluid volume into a space having a lower pressure, while at the same time the compensation of the fluid volume with a space having a higher pressure is blocked. In a customary implementation with orifices, this would result in that, in contrast to a unidirectional control valve, a double number of orifices requiring installation space would be necessary. The implementation according to the invention thus allows keeping installation space, number of components and thus costs at a low level.

It is moreover proposed that the bidirectional control valve is specifically implemented for achieving a capability for regulating a pressure drop at the valve slide, starting from a volume flow of less than 10 l/min, preferably less than 5 l/min and preferably less than 2 l/min. In this way, advantageous damping properties/damping characteristics are achievable. In particular, an opening point/inflection point of the bidirectional control valve is below 10 l/min, preferably below 5 l/min and preferentially below 2 l/min.

Furthermore, it is proposed that the bidirectional control valve comprises a first tank, in particular for a shock absorber rebound stage, and a second tank that is separable from the first tank by the valve slide, in particular for a shock absorber compression stage, the bidirectional control valve further comprising a pressure fluid reservoir the volume of which is variable by a movement of the valve slide, which is realized separately from the tanks and which is partially fillable and/or partially emptyable by a flow-through of the valve slide, wherein the hydraulic link valve that is realized as a two-pressure valve is configured to automatically and dynamically create a valve-slide flow-through connection between the pressure fluid reservoir and only that one of the two tanks which currently has a lower pressure load, in particular which is currently pressure-free. In this way, advantageous damping properties/damping characteristics are achievable, which preferably permit high dynamics with low leakages. In particular, the first tank is realized as a first chamber of a piston rod of a shock absorber. In particular, the second tank is realized as a second chamber of the piston rod of the shock absorber.

In addition, a vehicle with the bidirectional control valve is proposed, which has an advantageously comfortable chassis.

Furthermore, a method for an automatic adjustment of instantaneous flow-through directions by means of flow-through valve slides is proposed, wherein the instantaneous flow-through directions are automatically adjusted dynamically by the two-pressure valve, which is in particular at least partially integrated in the valve slide, and by the shuttle valve, which is in particular at least partially integrated in the valve slide, or by the 4/2 shuttle valve, which is in particular at least partially integrated in the valve slide. In this way, advantageous damping properties are achievable. Advantageously, a damping characteristic for shock absorbers is achievable which at the same time has high dynamics and low overall leakage.

The valve slide according to the invention, the control valve according to the invention, the vehicle according to the invention and the method according to the invention shall not be limited to the above-described application and implementation. In particular, in order to fulfil a functionality that is described here, the valve slide according to the invention, the control valve according to the invention, the vehicle according to the invention and the method according to the invention may have a number of individual elements, components, method steps and units that differs from a number given here.

### DRAWINGS

Further advantages will become apparent from the following description of the drawings. Two exemplary embodiments of the invention are illustrated in the drawings. The drawings, the description and the claims contain a plurality of features in combination. Someone skilled in the art will purposefully also consider the features individually and will find further expedient combinations.

In the drawings:

FIG. 1 shows a schematic illustration of a vehicle with a bidirectional control valve,

FIG. 2 shows a schematic section, taken in a first sectional plane, through the control valve with a flow-through hydraulic valve slide,

FIG. 3 shows a damping characteristic diagram of the control valve,

FIG. 4 shows a detail of a further schematic section, taken in a second sectional plane that is different from the first sectional plane, through the control valve with the valve slide,

FIG. 5 shows a detail of a further schematic section, taken in a third sectional plane that is different from the first sectional plane and the second sectional plane, through the control valve with the valve slide,

FIG. 6 shows a schematic flow chart of a method for an automatic adjustment of instantaneous flow-through directions by means of the valve slide of the control valve,

FIG. 7a shows a schematic hydraulic circuit diagram of the control valve according to the invention,

FIG. 7b shows a schematic hydraulic circuit diagram of a control valve known from the prior art,

FIG. 8 schematically shows a perspective view of an alternative flow-through hydraulic valve slide for an alternative bidirectional control valve, and

FIG. 9 shows a schematic section through a portion of the alternative control valve with the alternative valve slide.

### DESCRIPTION OF THE EXEMPLARY EMBODIMENTS

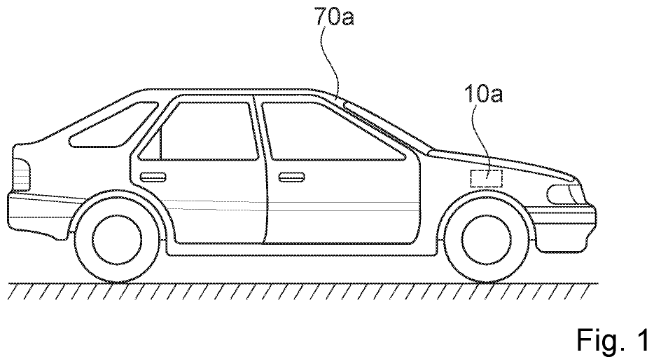

FIG. 1 schematically shows a vehicle 70a with a bidirectional control valve 10a. The vehicle 70a is designed as a passenger car. Alternative vehicles having chassis, such as other road vehicles, agricultural vehicles, rail vehicles, aircraft etc., are also conceivable. The bidirectional control valve 10a is configured for regulating damping characteristics, in particular of shock absorbers (not shown) of the vehicle 70a. By means of the bidirectional control valve 10a according to the invention, a capability for regulating a pressure drop at a valve slide 14a of the bidirectional control valve 10a can be achieved, starting from a volume flow of less than 10 l/min, preferably less than 5 l/min and preferentially less than 2 l/min.

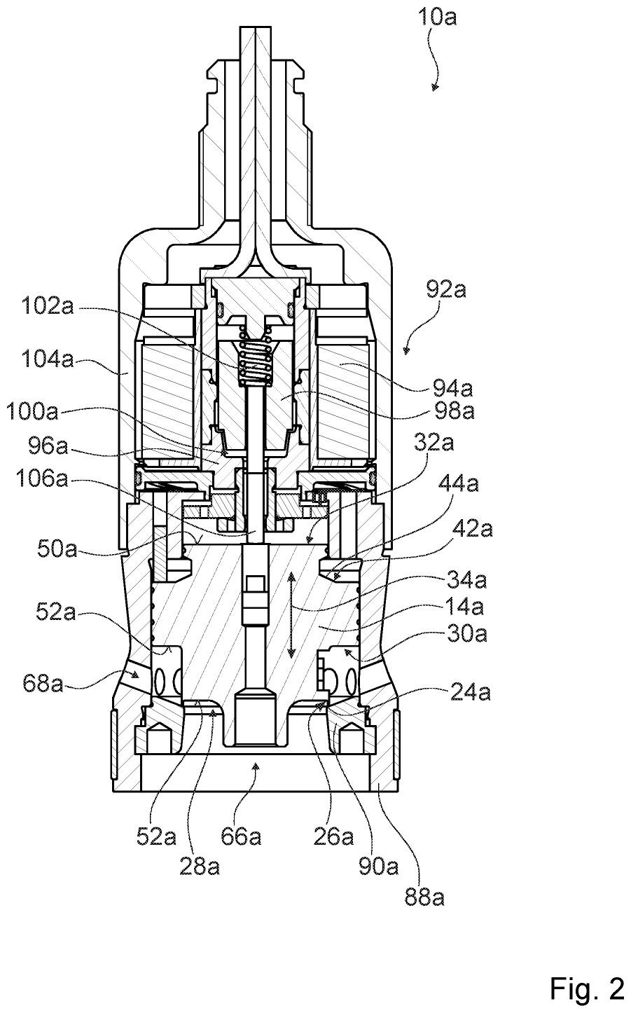

FIG. 2 shows a schematic section, taken in a first sectional plane, through the control valve 10a. The control valve 10a comprises the valve slide 14a. The valve slide 14a is implemented in such a way that it can be flowed through. The valve slide 14a can be flowed through by a pressure fluid of a hydraulic system. The control valve 10a comprises a first pressure port 84a (cf. FIG. 4). The control valve 10a comprises a first tank 66a. The first tank 66a is fluidically connected to the first pressure port 84a. The control valve 10a comprises a second pressure port 86a (cf. FIG. 4). The control valve 10a comprises a second tank 68a. The second tank 68a is separable from the first tank 66a in a fluid-tight manner. The tanks 66a, 68a are separable from each other by the valve slide 14a. The second tank 68a is fluidically connected to the second pressure port 86a. The tensile forces and compressive forces that are to be damped by the shock absorber act on the pressure ports 84a, 86a. For example, shock absorber compressive forces generate a pressure acting on the valve slide 14a at the first pressure port 84a, and shock absorber tensile forces generate a pressure acting on the valve slide 14a at the second pressure port 86a. If shock absorber compressive forces act on the valve slide 14a, the second pressure port 86a implements a pressure-free side of the control valve 10a. If shock absorber tensile forces act on the valve slide 14a, the first pressure port 84a implements a pressure-free side of the control valve 10a. If the pressure applied at the valve slide 14a exceeds a limit value (opening pressure), the valve slide 14a opens a connection between the two pressure ports 84a, 86a. The pressure ports 84a, 86a are realized as openings in a valve housing 88a of the control valve 10a. The valve slide 14a is herein arranged completely within the valve housing 88a. The valve housing 88a of the control valve 10a, in particular a valve seat element 90a that is connected to the valve housing 88a, forms a valve seat 24a. The valve slide 14a is configured to sit on the valve seat 24a in a sealing manner. In a movement of the valve slide 14a along a designated movement direction 34a of the valve slide 14a, the valve seat 24a opens and closes. The valve slide 14a is configured to generate, depending on its opening position, a damping of the tensile forces or compressive forces applied at the control valve 10a. If an engaging tensile or compressive force is large enough to lift the valve slide 14a from the valve seat 24a, a pressure fluid will flow between the pressure ports 84a, 86a, as a result of which a damping of the engaging tensile or compressive forces will be generated. By an adjustment of a force with which the valve slide 14a is pressed onto the valve seat 24a, a damping hardness of the control valve 10a, in particular of the chassis damper, can be adjusted. If the valve slide 14a is pressed strongly onto the valve seat 24a, the damping characteristic is hard. If the valve slide 14a is pressed less strongly onto the valve seat 24a, the damping characteristic is soft. The valve slide 14a comprises a sealing surface 26a. The sealing surface 26a is configured for a (fluid-)tight sitting of the valve slide 14a on the valve seat 24a of the control valve 10a.

The control valve 10a comprises an electromagnet 92a. The electromagnet 92a comprises a magnet coil 94a. The electromagnet 92a is configured to adjust a force required for lifting the valve slide 14a from the valve seat 24a. Depending on a magnetic field strength generated by the magnet coil 94a, the force required for lifting the valve slide 14a from the valve seat 24a increases. The electromagnet 92a is realized as a reluctance magnet. The electromagnet 92a comprises a magnetic core 96a. The magnetic core 96a is to a large portion arranged in an interior of the magnet coil 94a. The magnetic core 96a protrudes from the interior of the magnet coil 94a towards the valve slide 14a. The control valve 10a comprises a main armature 98a. The main armature 98a is realized as a magnet armature comprising a ferromagnetic material. The main armature 98a is arranged in the interior of the magnet coil 94a. The main armature 98a is movably supported in the interior of the magnet coil 94a. An air gap 100a of the electromagnet 92a that is realized as a reluctance magnet is arranged between the main armature 98a and the magnetic core 96a. The main armature 98a is pulled towards the magnetic core 96a and/or held in a position close to the magnetic core 96a by the magnetic field of the magnet coil 94a. On a side opposite the magnetic core 96a, the main armature 98a is supported on an upper side of the control valve 10a by a compression spring 102a. The electromagnet 92a comprises a magnet housing 104a that surrounds the magnet coil 94a. The valve housing 88a and the magnet housing 104a are sealingly connected to each other. The control valve 10a, in particular the electromagnet 92a, comprises a tappet element 106a. The tappet element 106a is fixedly connected to the main armature 98a or is supported on the main armature 98a. The tappet element 106a is configured to transmit a force generated by the main armature 98a to the valve slide 14a. The tappet element 106a protrudes from the interior of the magnet coil 94a towards the valve slide 14a. The tappet element 106a can be operated by the magnet coil 94a. The tappet element 106a is configured to adjust, in an energized (normal) operation state, a variable damping characteristic of the control valve 10a depending on the magnetic field strength generated by the magnet coil 94a. The control valve 10a comprises a pressure fluid reservoir 42a. The pressure fluid reservoir 42a is variable with respect to its volume by a movement of the valve slide 14a. The pressure fluid reservoir 42a is partially fillable and partially emptyable by the flow-through of the valve slide 14a with the pressure fluid (for example oil). The pressure fluid reservoir 42a is realized separately from the tanks 66a, 68a. Furthermore, with regard to the implementation and functionality of the control valve 10a, reference is made to the German patent application with the application number 10 2021 134 565.0, the content of which is herewith entirely incorporated into the present patent application.

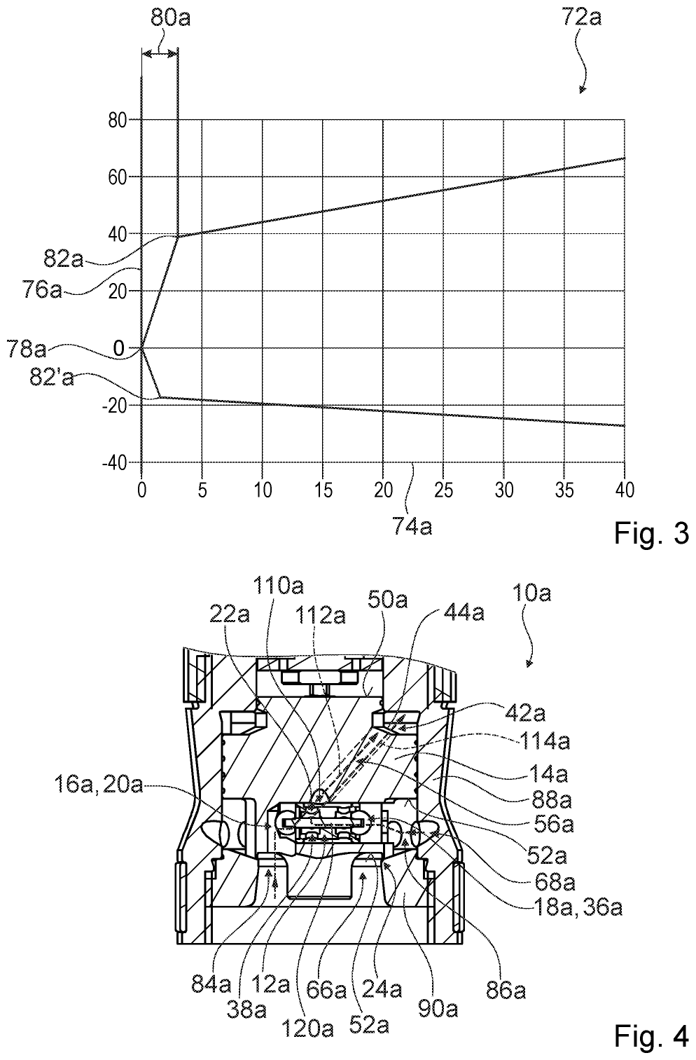

FIG. 3 shows by way of example a damping characteristic diagram 72a of the control valve 10a according to the invention with the valve slide 14a according to the invention, in which a damper speed (in l/min) is plotted on an abscissa 74a and in which a damper force/a pressure (in bar) is plotted on an ordinate 76a. Herein positive damper forces correspond to compressive forces and negative damper forces correspond to tensile forces. A narrow region of strong slope, starting from a zero point 78a of the damping characteristic diagram 72a, indicates a respective leakage 80a of the control valve 10a in the rebound direction and in the pressure direction. The points in which the slopes decrease are referred to as opening points 82a, 82′a of the control valve 10a and indicate when the valve slide 14a—and not leakages of the valve slide 14a or other components—starts determining the damping characteristic. The strength of the damper force (i.e. the “height” of the solid line) is adjustable by a regulation of the magnetic field strength of the electromagnet 92a. The solid lines indicate a damping characteristic in the energized (normal) operation state for a specific magnetic field.

FIG. 4 shows a detail of a further schematic section, taken in a second sectional plane that is different from the first sectional plane, through the control valve 10a. The valve slide 14a can be flowed through. The valve slide 14a is configured as a flow-through hydraulic valve slide 14a. The valve slide 14a comprises a hydraulic link valve 12a. The hydraulic link valve 12a is integrated in the valve slide 14a. The hydraulic link valve 12a shown in FIG. 4 is realized as a two-pressure valve 38a.

The two-pressure valve 38a comprises a valve slide 120a, which is configured to adjust the opening position of the two-pressure valve 38a. The hydraulic link valve 12a is configured for an influencing of the flow-through of the valve slide 14a. The hydraulic link valve 12a comprises a first control port 16a. The hydraulic link valve 12a comprises a first entry 20a. In the case shown in FIG. 4, the first control port 16a and the first entry 20a coincide (in one element). The hydraulic link valve 12a comprises a second control port 18a. The hydraulic link valve 12a comprises a second entry 36a. In the case shown in FIG. 4, the second control port 18a and the second entry 36a coincide (in one element). The hydraulic link valve 12a comprises an exit 22a (here: exactly one exit 22a). The exit 22a is arranged separately from the control ports 16a, 18a. Depending on a position of the hydraulic link valve 12a, the exit 22a can be opened in an interchangeable manner towards one of the entries 20a, 36a. The two-pressure valve 38a is configured to automatically and dynamically create a valve-slide flow-through connection between the pressure fluid reservoir 42a and only that one of the two tanks 66a, 68a which currently has a lower pressure load, in particular which is currently pressure-free.

The first control port 16a is hydraulically connected to a first side 28a of the valve slide 14a. The second control port 18a is hydraulically connected to a second side 30a of the valve slide 14a. The two sides 28a, 30a which the control ports 16a, 18a are hydraulically connected to are arranged relative to the valve slide 14a/on the valve slide 14a in such a way that the first side 28a and the second side 30a can be sealed (in a fluid-tight manner) against each other by the sealing surface 26a of the valve slide 14a. The exit 22a of the hydraulic link valve 12a of FIG. 4 is hydraulically connected to a third side 32a of the valve slide 14a. Viewed in the designated movement direction 34a of the valve slide 14a, the third side 32a of the valve slide 14a is arranged opposite the sealing surface 26a of the valve slide 14a.

The two-pressure valve 38a is configured to open and/or keep open the entry 20a, 36a, to which the control port 16a, 18a having the lower pressure is assigned, towards the exit 22a. The valve slide 14a comprises a flow channel 56a. The flow channel 56a is configured as a recess in the valve slide 14a. The hydraulic link valve 12a (the two-pressure valve 38a) is assigned to the flow channel 56a. The flow channel 56a comprises three partial flow channels: one partial flow channel connected to the first entry 20a of the hydraulic link valve 12a, one partial flow channel connected to the second entry 36a of the hydraulic link valve 12a and one partial flow channel connected to the exit 22a of the hydraulic link valve 12a. The partial flow channels of the flow channel 56a may be realized as bores in the valve slide 14a. The flow channel 56a has a branching 110a. In the branching 110a, three sub-channels of the flow channel 56a meet, which respectively open into one of the aforementioned partial flow channels. The flow channel 56a comprises a first flow-through path 112a. The first flow-through path 112a extends via the branching 110a between the partial flow channel connected to the first entry 20a of the hydraulic link valve 12a and the partial flow channel connected to the exit 22a of the hydraulic link valve 12a. The flow channel 56a comprises a second flow-through path 114a. The second flow-through path 114a extends via the branching 110a between the partial flow channel connected to the second entry 36a of the hydraulic link valve 12a and the partial flow channel connected to the exit 22a of the hydraulic link valve 12a. Both flow-through paths 112a, 114a of the flow channel 56a open into the partial flow channel that is connected to the exit 22a of the hydraulic link valve 12a. The partial flow channel which starts from the exit 22a extends obliquely/at an angle relative to the designated movement direction 34a of the valve slide 14a.

The exit 22a of the two-pressure valve 38a is hydraulically connected to a region 44a of the valve slide 14a that is configured to at least partially delimit the pressure fluid reservoir 42a of the control valve 10a. The pressure fluid reservoir 42a is configured to be filled and/or emptied during a movement of the valve slide 14a via one of the flow-through paths 112a, 114a that is controlled at least by the two-pressure valve 38a. The pressure fluid reservoir 42a is partially delimited by the valve housing 88a. The pressure fluid reservoir 42a is realized by an interaction of the valve slide 14a and the valve housing 88a. In the state of the two-pressure valve 38a shown by way of example in FIG. 4, the first flow-through path 112a is open and the second flow-through path 114a is closed. In this case, the higher pressure thus acts on the second control port 18a.

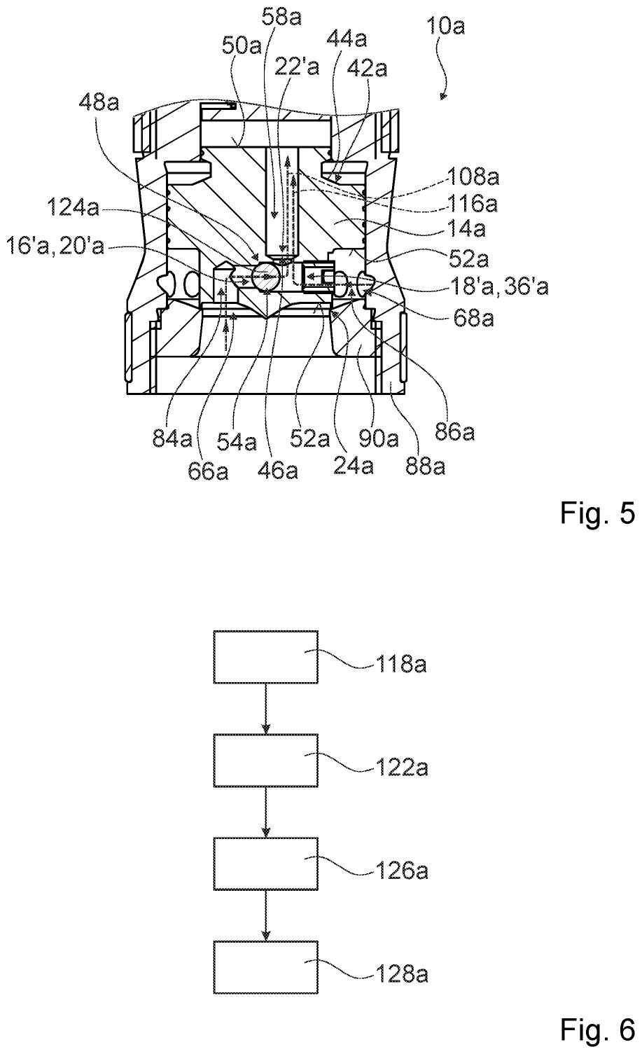

FIG. 5 shows a detail of a further schematic section, taken in a third sectional plane that is different from the first sectional plane and the second sectional plane, through the control valve 10a. The valve slide 14a comprises a further hydraulic link valve 54a. The further hydraulic link valve 54a is realized differently from the hydraulic link valve 12a. The further hydraulic link valve 54a differs from the hydraulic link valve 12a in a functional principle. The further hydraulic link valve 54a is integrated in the valve slide 14a. The further hydraulic link valve 54a is realized separately from the hydraulic link valve 12a. The further hydraulic link valve 54a is also configured for influencing a flow-through of the valve slide 14a. The further hydraulic link valve 54a shown in FIG. 5 is realized as a shuttle valve 48a. The further hydraulic link valve 54a comprises a first control port 16′a. The further hydraulic link valve 54a comprises a first entry 20′a. In the case shown in FIG. 5, the first control port 16′a and the first entry 20′a coincide (in one element). The further hydraulic link valve 54a comprises a second control port 18′a. The further hydraulic link valve 54a comprises a second entry 36′a. In the case shown in FIG. 5, the second control port 18′a and the second entry 36′a coincide (in one element). The further hydraulic link valve 54a comprises an exit 22′a (here: exactly one exit). The exit 22′a is arranged separately from the control ports 16′a, 18′a. Depending on a position of the further hydraulic link valve 54a, the exit 22′a can be opened in an interchangeable manner towards one of the entries 20′a, 36′a. The shuttle valve 48a comprises a valve element 124a (here: illustrated as a valve ball), which is configured to adjust the opening position of the shuttle valve 48a.

The first control port 16′a of the further hydraulic link valve 54a is hydraulically connected to the first side 28a of the valve slide 14a. The second control port 18′a of the further hydraulic link valve 54a is hydraulically connected to the second side 30a of the valve slide 14a. The two sides 28a, 30a, to which the control ports 16′a, 18′a of the further hydraulic link valve 54a are hydraulically connected, are arranged relative to the valve slide 14a/on the valve slide 14a in such a way that the first side 28a and the second side 30a can be sealed (in a fluid-tight manner) against each other by the sealing surface 26a of the valve slide 14a. The exit 22′a of the further hydraulic link valve 54a of FIG. 4 is hydraulically connected to the third side 32a of the valve slide 14a. The exit 22′a of the shuttle valve 48a is hydraulically connected to a hydraulic effective surface 50a of the valve slide 14a situated opposite a further hydraulic effective surface 52a of the valve slide 14a, which is realized on that side 28a, 30a of the valve slide 14a towards which the shuttle valve 48a is currently open. The opposite-situated hydraulic effective surfaces 50a, 52a have different dimensions (for further explanations see also the disclosure of the German patent application filed with the application number 10 2021 134 565.0). The exit 22′a of the shuttle valve 48a is realized and arranged differently and separately from the exit 22a of the two-pressure valve 38a. The entries 20′a, 36′a of the shuttle valve 48a are in each case realized and arranged differently and separately from the entries 20a, 36a of the two-pressure valve 38a.

The shuttle valve 48a is configured to open and/or keep open the entry 20′a, 36′a, to which the control port 16′a, 18′a having the higher pressure is assigned, towards the exit 22′a. The valve slide 14a comprises a further flow channel 58a. The further flow channel 58a is realized as a recess in the valve slide 14a. The further hydraulic link valve 54a (the shuttle valve 48a) is assigned to the further flow channel 58a. The two flow channels 56a, 58a are completely separate from each other. The two flow channels 56a, 58a are realized without connection to each other. The further flow channel 58a comprises three partial flow channels: one partial flow channel connected to the first entry 20′a of the further hydraulic link valve 54a, one partial flow channel connected to the second entry 36′a of the further hydraulic link valve 54a, and one partial flow channel connected to the exit 22′a of the further hydraulic link valve 54a. The further flow channel 58a comprises a further branching 46a. In the further branching 46a, three sub-channels of the further flow channel 58a meet, which respectively open into one of the aforementioned partial flow channels. The further flow channel 58a comprises a third flow-through path 108a. The third flow-through path 108a extends via the branching 46a between the partial flow channel connected to the first entry 20′a of the further hydraulic link valve 54a and the partial flow channel connected to the exit 22′a of the further hydraulic link valve 54a. The further flow channel 58a comprises a fourth flow-through path 116a. The fourth flow-through path 116a extends via the branching 46a between the partial flow channel connected to the second entry 36′a of the further hydraulic link valve 54a and the partial flow channel connected to the exit 22′a of the further hydraulic link valve 54a. Both flow-through paths 108a, 116a of the further flow channel 58a open into the partial flow channel that is connected to the exit 22′a of the further hydraulic link valve 54a. The partial flow channel which starts from the exit 22′a of the further hydraulic link valve 54a extends parallel to the designated movement direction 34a of the valve slide 14a.

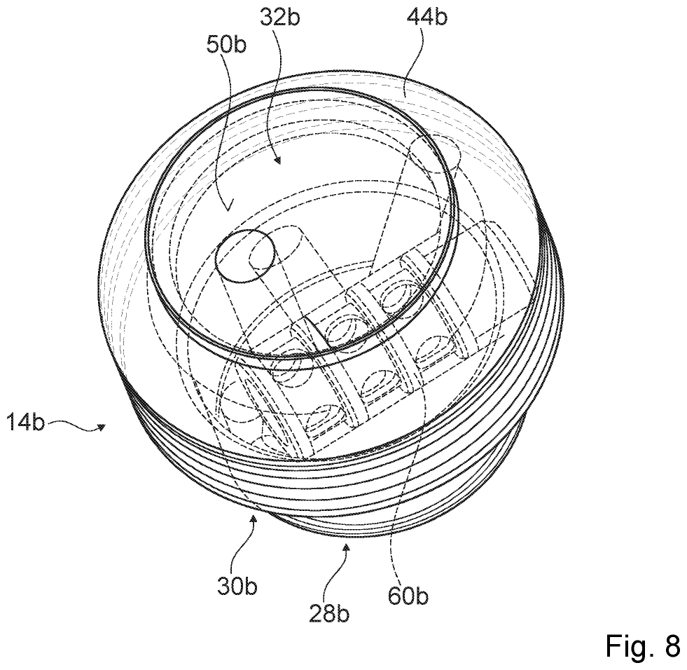

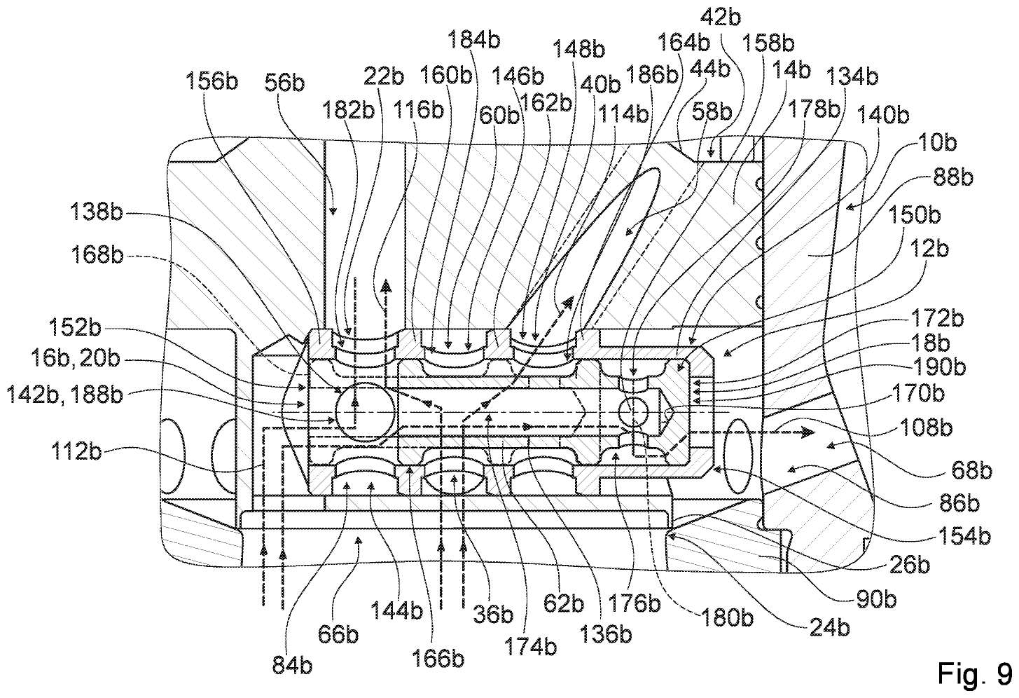

FIG. 6 shows a schematic flow chart of a method for an automatic adjustment of instantaneous flow-through directions by means of the flow-through hydraulic valve slide 14a of the control valve 10a. In the method, an instantaneous flow-through direction is automatically adjusted dynamically by the two-pressure valve 38a, which is at least partially integrated in the valve slide 14a, and by the shuttle valve 48a, which is at least partially integrated in the valve slide 14a. Alternatively, instead of the combination of two-pressure valve 38a and shuttle valve 48a, it is also possible to use a 4/2 shuttle valve 60b, which is at least partially integrated in the valve slide 14b, as shown in the following FIGS. 8 and 9. In the following, the behavior of the control valve 10a when a pressure to be damped is applied to the second tank 68a will be described by way of example and schematically (cf. also FIGS. 4 and 5). In at least one method step 118a, the two-pressure valve 38a is actuated by the applied pressure in such a way that the valve slide 120a of the two-pressure valve 38a is pushed by the applied pressure into a position in which the valve slide 120a of the two-pressure valve 38a opens the first flow-through path 112a and closes the second flow-through path 114a. In this way a fluidic connection of the currently pressure-free first tank 66a to the pressure fluid reservoir 42a is created. The pressure fluid reservoir 42a could thus be filled or emptied in a resistance-free manner during a movement of the valve slide 14a (if, for example, the applied pressure exceeds the limit value of the opening point 82a). In at least one further method step 122a, the valve element 124a of the shuttle valve 48a is (substantially simultaneously) pushed by the applied pressure into a position in which the valve element 124a of the shuttle valve 48a closes the third flow-through path 108a and opens the fourth flow-through path 116a. In this way a fluidic connection of the second tank 68a, at which the pressure is applied, to the hydraulic effective surface 50a of the valve slide 14a is created. The applied pressure is thus forwarded to the hydraulic effective surface 50a of the valve slide 14a. In at least one further method step 126a, a resisting force of the valve slide 14a against a lifting of its sealing surface 26a from the valve seat 24a is adjusted by selecting an energization of the magnet coil 94a of the electromagnet 92a. In at least one further method step 128a, if the limit value given by the opening point 82a is exceeded by the applied pressure, the valve slide 14a is lifted from the valve seat 24a, such that pressure fluid can flow from the second tank 68a into the first tank 66a (or vice versa). In this way a damping of the applied pressure is created/achieved.

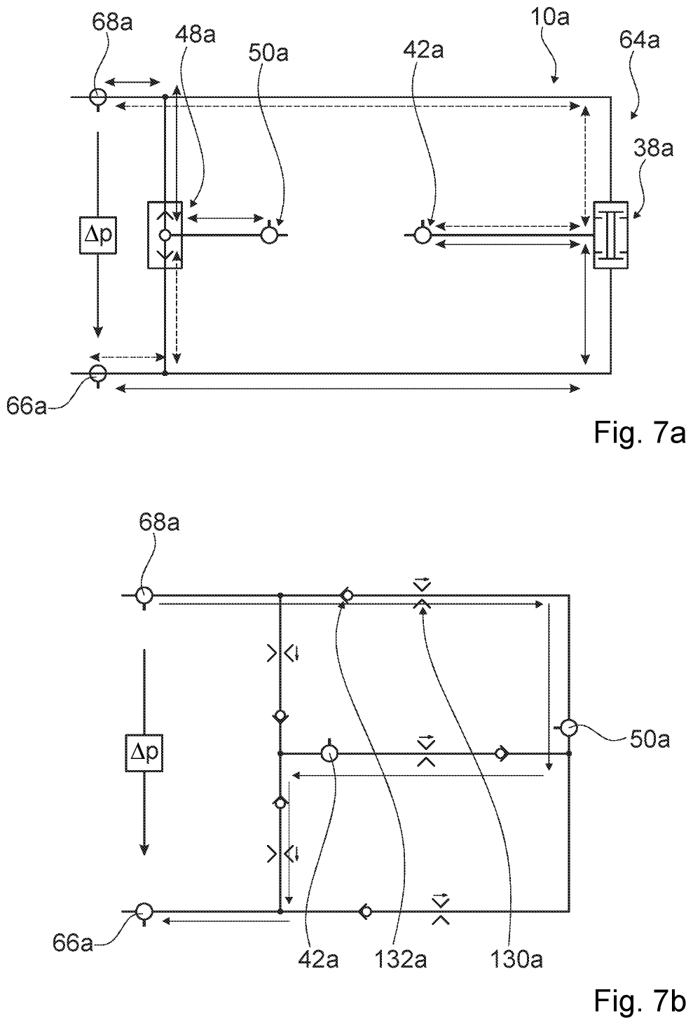

FIG. 7a shows a schematic hydraulic circuit diagram of the control valve 10a according to the invention. Apart from the hydraulic link valve 12a and apart from the further hydraulic link valve 54a, the flow-through hydraulic valve slide 14a has an orifice-free configuration 64a. FIG. 7b shows a schematic hydraulic circuit diagram of a control valve known from the prior art with a plurality of orifices 130a and check valves 132a.

A further exemplary embodiment of the invention is shown in FIGS. 8 and 9. The following descriptions and the drawings are substantially limited to the differences between the exemplary embodiments, wherein with regard to components having the same denomination, in particular with regard to components having the same reference numerals, reference may in principle also be made to the drawings and/or the description of the other exemplary embodiments, in particular of FIGS. 1 to 7a. To distinguish between the exemplary embodiments, the letter a has been added to the reference numerals of the exemplary embodiment in FIGS. 1 to 7b. In the exemplary embodiments of FIGS. 8 and 9, the letter a has been replaced by the letter b.

FIG. 8 schematically shows a perspective illustration of an alternative flow-through hydraulic valve slide 14b. The alternative valve slide 14b can be used in a control valve 10b which, apart from the valve slide 14b, is identical to the control valve 10a already described. The alternative valve slide 14b fulfils the same function as the valve slide 14a already described. The alternative valve slide 14b comprises an alternative hydraulic link valve 12b. The alternative hydraulic link valve 12b is integrated in the valve slide 14b. The alternative hydraulic link valve 12b is realized as a single valve. The single valve is realized as a 4/2 shuttle valve 60b. The 4/2 shuttle valve 60b combines the function of a shuttle valve with the function of a two-pressure valve in one valve.

FIG. 9 shows a schematic section through a portion of the alternative valve slide 14b and through the alternative hydraulic link valve 12b that is realized as a 4/2 shuttle valve 60b. The 4/2 shuttle valve 60b comprises a first control port 16b. The 4/2 shuttle valve 60b comprises a first entry 20b. In the case shown in FIG. 9, the first control port 16b and the first entry 20b coincide (in one element). The 4/2 shuttle valve 60b comprises a second control port 18b. The 4/2 shuttle valve 60b comprises a second entry 36b. The second entry 36b is fluidically connected to a second tank 68b. The external pressure of the shock absorber can be applied at the second entry 36b. In the case shown in FIG. 9, the second control port 18b and the second entry 36b are separate/different from each other. The 4/2 shuttle valve 60b comprises an exit 22b. The exit 22b is arranged/realized separately from the control ports 16b, 18b and from the entries 20b, 36b. Depending on an adjustment of the 4/2 shuttle valve 60b, the exit 22b can be opened in an interchangeable manner towards one of the entries 20b, 36b. The 4/2 shuttle valve 60b comprises a further exit 40b. The further exit 40b is arranged/realized separately from the control ports 16b, 18b and from the entries 20b, 36b. Depending on an adjustment of the 4/2 shuttle valve 60b, the further exit 40b can be opened in an interchangeable manner towards one of the entries 20b, 36b.

The 4/2 shuttle valve 60b is configured to open and/or keep open the entry 20b, 36b, to which the control port 16b, 18b having the lower pressure is assigned, towards the exit 22b. The 4/2 shuttle valve 60b is configured to at the same time open and/or keep open the entry 20b, 36b, to which the control port 16b, 18b having the higher pressure is assigned, towards the further exit 40b. The valve slide 14b comprises a flow channel 56b and a further flow channel 58b. The 4/2 shuttle valve 60b is assigned to both flow channels 56b, 58b. The flow channel 56b comprises a first flow-through path 112b. The first flow-through path 112b extends between a partial flow channel connected to the first entry 20b of the 4/2 shuttle valve 60b and to a first tank 66b of the control valve 10b and a partial flow channel connected to the exit 22b of the 4/2 shuttle valve 60b and to a hydraulic effective surface 50b that is situated opposite the first tank 66b. The flow channel 56b comprises a second flow-through path 114b. The second flow-through path 114b extends between a partial flow channel connected to the second entry 36b of the 4/2 shuttle valve 60b and to the second tank 68b of the control valve 10b and a partial flow channel connected to the exit 22b of the 4/2 shuttle valve 60b and to the hydraulic effective surface 50b. Both flow-through paths 112b, 114b of the flow channel 56b thus open into the partial flow channel that is connected to the exit 22b of the 4/2 shuttle valve 60b.

The further flow channel 58b comprises a third flow-through path 108b. The third flow-through path 108b extends between a partial flow channel connected to the first entry 20b of the 4/2 shuttle valve 60b and to the first tank 66b of the control valve 10b and a partial flow channel connected to the second exit 40b of the 4/2 shuttle valve 60b and to a pressure fluid reservoir 42b of the control valve 10b. The further flow channel 58b comprises a fourth flow-through path 116b. The fourth flow-through path 116b extends between a partial flow channel connected to the second entry 36b of the 4/2 shuttle valve 60b and to the second tank 68b of the control valve 10b and the partial flow channel connected to the second exit 40b of the 4/2 shuttle valve 60b and to the pressure fluid reservoir 42b of the control valve 10b. Both flow-through paths 108b, 116b of the further flow channel 58b thus open into the partial flow channel that is connected to the further exit 40b of the 4/2 shuttle valve 60b.

The 4/2 shuttle valve 60b is thus configured to open and/or keep open the entry 20b, 36b, which is assigned to that control port 16b, 18b of the two control ports 16b, 18b at which the higher pressure is applied, towards the exit 22b and at the same time to open and/or keep open the entry 20b, 36b, which is assigned to that control port 16b, 18b of the two control ports 16b, 18b at which the lower pressure is applied, towards the further exit 40b.

The 4/2 shuttle valve 60b comprises a first valve part 134b and a second valve part 136b. The first valve part 134b is inserted in a sealing manner into a recess 140b of the valve slide 14b. The first valve part 134b forms five regions 142b, 144b, 146b, 148b, 150b (first region 142b, second region 144b, third region 146b, fourth region 148b, fifth region 150b). The regions 142b, 144b, 146b, 148b, 150b are respectively sealable relative to each other (depending on a position of the second valve part 136b) and/or selectively combinable with respectively one of the further regions 142b, 144b, 146b, 148b, 150b (depending on a position of the second valve part 136b). The first region 142b is arranged in the axial direction 158b of the 4/2 shuttle valve 60b outside the 4/2 shuttle valve 60b on a first axial side 152b of the first valve part 134b. The second valve part 136b is supported so as to be movable in the axial direction 158b. The first region 142b is fluidically connected to the first tank 66b. The first region 142b is sealed at the outer circumference of the 4/2 shuttle valve 60b by a first seal 156b of the first valve part 134b with respect to the further regions 144b, 146b, 148b, 150b. The second region 144b is fluidically connected to the hydraulic effective surface 50b. The second region 144b is sealed at the outer circumference of the 4/2 shuttle valve 60b on one side by the first seal 156b with respect to the first region 142b and on an opposite-situated side by a second seal 160b of the first valve part 134b with respect to the further regions 146b, 148b, 150b. The third region 146b is fluidically connected to the second tank 68b. The third region 146b is sealed at the outer circumference of the 4/2 shuttle valve 60b on one side by the second seal 160b with respect to the first region 142b and the second region 144b and on an opposite-situated side by a third seal 162b of the first valve part 134b with respect to the further regions 148b, 150b. The fourth region 148b is fluidically connected to the pressure fluid reservoir 42b. The fourth region 148b is sealed at the outer circumference of the 4/2 shuttle valve 60b on one side by the third seal 162b with respect to the first region 142b, the second region 144b and the third region 146b and on an opposite-situated side by a fourth seal 164b of the first valve part 134b with respect to the fifth region 150b. The fifth region 150b is arranged in the axial direction 158b of the 4/2 shuttle valve 60b outside the 4/2 shuttle valve 60b on a second axial side 154b of the first valve part 134b. The fifth region 150b is fluidically connected to the second tank 68b. The fifth region 150b is sealed at the outer circumference of the 4/2 shuttle valve 60b by the fourth seal 164b of the first valve part 134b with respect to the further regions 142b, 144b, 146b, 148b.

The second valve part 136b is arranged within the first valve part 134b. The second valve part 136b is arranged so as to be axially movable in the first valve part 134b. The second valve part 136b glides in a sealing manner within a recess 138b of the first valve part 134b. The second valve part 136b forms a combination-valve valve slide 62b that is at least section-wise capable of being flowed through. The second valve part 136b is configured to be moved back and forth between a first valve position 166b and a second valve position 168b. In FIG. 9, the second valve part 136b is in the first valve position 166b, while the second valve position 168b is indicated only by dashed lines. The second valve part 136b is configured to be brought into the respective valve position 166b, 168b by the pressures applied at the control ports 16b, 18b. For this purpose, the second valve part 136b comprises a first pressure-application surface 170b and a second pressure-application surface 172b. The first pressure-application surface 170b is configured for applying a pressure from the first tank 66b/from the first control port 16b. The second pressure-application surface 172b is configured for applying a pressure from the second tank 68b/from the second control port 18b. The flow-through combination-valve valve slide 62b comprises a flow-through recess 174b. The flow-through recess 174b can be filled with the pressure fluid/flowed through by the pressure fluid. The flow-through recess 174b is open axially towards the first axial side 152b. The flow-through recess 174b is closed axially towards the second axial side 154b. In an end region 176b of the second valve part 136b situated at the second axial side 154b, the flow-through recess 174b comprises at least one inflow and/or outflow opening 178b, which enables an inflow and/or an outflow of pressure fluid in a direction 180b that is radial to the axial direction 158b. Along the remaining portion of its extent in the axial direction 158b, the second valve part 136b is free of further inflow and/or outflow openings. The first pressure-application surface 170b and the second pressure-application surface 172b are both arranged in the same end region 176b of the second valve part 136b, in particular in the end region 176b of the second valve part 136b that is situated at the second axial side 154b. The first pressure-application surface 170b is arranged within the flow-through recess 174b of the second valve part 136b.

The second pressure-application surface 172b is arranged outside the flow-through recess 174b of the second valve part 136b. The second pressure-application surface 172b is arranged on an axial outer surface of the second valve part 136b.

In the second region 144b, the first valve part 134b comprises at least one inflow and/or outflow opening 182b on an outer circumference that is, in particular with respect to the axial direction 158b, situated in the radial direction 180b, said inflow and/or outflow opening 182b permitting a fluidic connection from an inner space of the first valve part 134b to the further hydraulic effective surface 54b. In the third region 146b, the first valve part 134b comprises, on an outer circumference that is, in particular with respect to the axial direction 158b, situated in a radial direction 180b, at least one inflow and/or outflow opening 184b permitting a fluidic connection from the inner space of the first valve part 134b to the second tank 68b. In the fourth region 148b, the first valve part 134b comprises, on an outer circumference that is, in particular with respect to the axial direction 158b, situated in a radial direction 180b, at least one inflow and/or outflow opening 186b permitting a fluidic connection from the inner space of the first valve part 134b to the pressure fluid reservoir 42b. The first region 142b and the fifth region 150b are in each case connected to the inner space of the first valve part 134b by axial inflow and/or outflow openings 188b, 190b.

In the first valve position 166b, the first region 142b is fluidically connected to the second region 144b. In the first valve position 166b, the third region 146b is fluidically connected to the fourth region 148b. In the first valve position 166b, the fifth region 150b is fluidically connected to none of the further regions 142b, 144b, 146b, 148b. In the first valve position 166b, the first region 142b and the second region 144b are fluidically separate from the further regions 146b, 148b, 150b. In the first valve position 166b, the third region 146b and the fourth region 148b are fluidically separate from the further regions 142b, 144b, 150b.

In the second valve position 168b, the first region 142b is fluidically connected to the fourth region 148b. In the second valve position 168b, the second region 144b is fluidically connected to the third region 146b. In the second valve position 168b, the fifth region 150b is fluidically connected to none of the further regions 142b, 144b, 146b, 148b. In the second valve position 168b, the volume of the fifth region 150b is larger than in the first valve position 166b. In the second valve position 168b, the first region 142b and the fourth region 148b are fluidically separate from the further regions 144b, 146b, 150b. In the second valve position 168b, the second region 144b and the third region 146b are fluidically separate from the further regions 142b, 148b, 150b.

### REFERENCE NUMERALS

10 control valve
12 link valve
14 valve slide
16 first control port
18 second control port
20 first entry
22 exit
24 valve seat
26 sealing surface
28 first side
30 second side
32 third side
34 movement direction
36 second entry
38 two-pressure valve
40 further exit
42 pressure fluid reservoir
44 region
46 further branching
48 shuttle valve
50 hydraulic effective surface
52 further hydraulic effective surface
54 further link valve
56 flow channel
58 further flow channel
60 4/2 shuttle valve
62 combination-valve valve slide
64 orifice-free configuration
66 first tank
68 second tank
70 vehicle
72 damping characteristic diagram
74 abscissa
76 ordinate
78 zero point
80 leakage
82 opening point
84 first pressure port
86 second pressure port
88 valve housing
90 valve seat element
92 electromagnet
94 magnet coil
96 magnetic core
98 main armature
100 air gap
102 compression spring
104 magnet housing
106 tappet element
108 third flow-through path
110 branching
112 first flow-through path
114 second flow-through path
116 fourth flow-through path
118 method step
120 valve slide
122 method step
124 valve element
126 method step
128 method step
130 orifice
132 check valve
134 first valve part
136 second valve part
138 recess
140 recess
142 first region
144 second region
146 third region
148 fourth region
150 fifth region
152 first axial side
154 second axial side
156 first seal
158 axial direction
160 second seal
162 third seal
164 fourth seal
166 first valve position
168 second valve position
170 first pressure-application surface
172 second pressure-application surface
174 flow-through recess
176 end region
178 inflow and/or outflow opening
180 radial direction
182 inflow and/or outflow opening
184 inflow and/or outflow opening
186 inflow and/or outflow opening
188 axial inflow and/or outflow opening
190 axial inflow and/or outflow opening

1. A flow-through hydraulic valve slide, in particular for a control valve for regulating damping characteristics of shock absorbers, with at least one hydraulic link valve for influencing a flow-through of the valve slide, wherein the hydraulic link valve comprises at least one first control port, at least one second control port, at least one entry and at least one exit which can be opened in an interchangeable manner at least towards the entry.

2. The flow-through hydraulic valve slide according to claim 1, comprising a sealing surface that is configured to tightly sit on a valve seat of the control valve, wherein the first control port is hydraulically connected to a first side of the valve slide, wherein the second control port is hydraulically connected to a second side of the valve slide, and wherein the two sides to which the control ports are hydraulically connected are arranged on the valve slide in such a way that the first side and the second side can be sealed relative to each other by the sealing surface.

3. The flow-through hydraulic valve slide according to claim 2, wherein the exit is hydraulically connected to a third side of the valve slide, which is arranged opposite the sealing surface as viewed in a designated movement direction of the valve slide.

4. The flow-through hydraulic valve slide according to claim 1 claim 1, wherein the hydraulic link valve is realized as a two-pressure valve, which is in particular configured to open and/or keep open the entry to which the control port having the lower pressure is assigned, towards the exit.

5. The flow-through hydraulic valve slide according to claim 4, wherein the exit of the two-pressure valve is hydraulically connected to a region of the valve slide that at least partially delimits a pressure fluid reservoir of the control valve, the pressure fluid reservoir being in particular configured to be filled and/or emptied during a movement of the valve slide via a flow-through path that is controlled at least by the two-pressure valve.

6. The flow-through hydraulic valve slide according to claim 1, wherein the hydraulic link valve is realized as a shuttle valve, which is in particular configured to open and/or keep open the entry to which the control port having the higher pressure is assigned towards the exit.

7. The flow-through hydraulic valve slide according to claim 6, wherein the exit of the shuttle valve is hydraulically connected to a hydraulic effective surface, which is situated opposite a further hydraulic effective surface that is realized on the side of the valve slide towards which the shuttle valve is currently open.

8. The flow-through hydraulic valve slide according to claim 7, wherein the opposite-situated hydraulic effective surfaces have different dimensions.

9. The flow-through hydraulic valve slide according to claim 1, comprising at least one further hydraulic link valve, which in particular differs from the hydraulic link valve in a functional principle, for influencing a flow-through of the valve slide, the further hydraulic link valve comprising at least one first control port and at least one second control port.

10. The flow-through hydraulic valve slide according to claim 9, wherein the hydraulic link valve is realized as a two-pressure valve and that the further hydraulic link valve is realized as a shuttle valve.

11. The flow-through hydraulic valve slide according to claim 9, wherein the hydraulic link valve is assigned to a flow channel realized at least partially by the valve slide and that the further hydraulic link valve is assigned to a further flow channel realized at least partially by the valve slide, wherein the two flow channels are realized completely separate from each other, in particular without connection to each other.

12. The flow-through hydraulic valve slide according to claim 1, wherein the hydraulic link valve is realized as a single valve, which has at least one further exit and which combines the function of a shuttle valve with the function of a two-pressure valve in one valve.

13. The flow-through hydraulic valve slide according to claim 12, wherein the single valve is realized as a 4/2 shuttle valve configured to open and/or keep open the entry, which is assigned to that control port of the two control ports at which a higher pressure is applied, towards the exit and at the same time to open and/or keep open the entry, which is assigned to that control port of the two control ports at which a lower pressure is applied, towards the further exit.

14. The flow-through hydraulic valve slide according to claim 12, wherein the hydraulic link valve realized as a 4/2 shuttle valve comprises a combination-valve valve slide that is at least section-wise capable of being flowed through.

15. The flow-through hydraulic valve slide according to claim 1, characterized by an orifice-free configuration, in particular apart from the hydraulic link valve and/or apart from the further hydraulic link valve.

16. A bidirectional control valve for regulating damping characteristics, in particular of shock absorbers, with a flow-through hydraulic valve slide according to claim 1.

17. The bidirectional control valve according to claim 16, comprising achieving a capability for regulating a pressure drop at the valve slide, starting from a volume flow of less than 10 l/min, preferably less than 5 l/min and preferentially less than 2 l/min.

18. The bidirectional control valve according to claim 16, with a first tank and with a second tank that is separable from the first tank by the valve slide, characterized by a pressure fluid reservoir the volume of which is variable by a movement of the valve slide, which is realized separately from the tanks and which is partially fillable and/or partially emptyable by a flow-through of the valve slide, wherein the hydraulic link valve realized as a two-pressure valve is configured to automatically and dynamically create a valve-slide flow-through connection between the pressure fluid reservoir and only that one of the two tanks which currently has a lower pressure load, in particular which is currently pressure-free.

19. A vehicle with a bidirectional control valve according to claim 16.

20. A method for an automatic adjustment of instantaneous flow-through directions by means of flow-through valve slides, in particular with a flow-through hydraulic valve slide according to claim 1, wherein the instantaneous flow-through directions are automatically adjusted dynamically by a two-pressure valve, which is in particular at least partially integrated in the valve slide, and by a shuttle valve, which is in particular at least partially integrated in the valve slide, or by a 4/2 shuttle valve, which is in particular at least partially integrated in the valve slide.
